(19) United States
(12) Patent Application Publication
(10) Pub. No.: US 2011/0312203 A1
(43) Pub. Date: Dec. 22, 2011

(54) Switch Pack Assembly for Cable Clusters of Network Switches and the Special Release Tool Assembly Thereof

(76) Inventors: Jony Liu, JiangSu (CN); Guanghui Hu, Jianghui (CN)

(21) Appl. No.: 13/142,972

(22) PCT Filed: Dec. 30, 2009
(86) PCT No.: PCT/US09/69827

§ 371 Date: Sep. 9, 2011

(30) Foreign Application Priority Data
Dec. 31, 2008 (CN) 200810184785.7

(51) Int. Cl. H01R 13/627; H01R 13/629

(52) U.S. Cl. 439/345; 439/296

(57) ABSTRACT

A switch pack assembly for cable clusters of network switches includes a central framework and two covers arranged movably at two sides of the central framework. Several longitudinal parallel holding troughs are arranged on the central framework. The main body of the cover covers the holding troughs to form cavities. Open windows are arranged at positions on the cover corresponding to the front parts of at least one pair of cavities. A longitudinal sliding guide component and a pulling resisting component are arranged on the outside of the switch pack assembly and are designed to interact with a release tool. A shape of a front end of the release tool matches a shape of the switch pack assembly. At the front end of the tool are arranged unlocking pressure plates to interact with snap latches of plugs in the open windows. At the inside of the tool are arranged a longitudinal sliding positioning mechanism to interact with the sliding guide component and a pulling force-applying mechanism to interact with the pulling resisting component. With these structures, the operation of plugging and pulling cables as a whole is convenient and quick.

### TECHNOLOGY FIELD

The present invention relates to the technical field of network switches, especially to the assembly structures for the plugs to mate to network switches, and the release of cables from network switches. In particular, the present invention relates to a switch pack assembly for cable clusters of network switches and the special release tool assembly thereof.

### BACKGROUND TECHNOLOGY

In the modern society, with the continuous development of science and technology, the contacts between people are becoming closer increasingly. The constructions of communication infrastructure are becoming more perfect and progressive, so as to improve the communication process between people. For network switches at the core position of the network, a small switch only has a few dozen of cable interfaces, while a large switch has hundreds or even thousands of cable interfaces. The intensive degree of cables on the switch can be imagined, and if one or one set of cables need to be plugged and pulled for debugging, it is very difficult and complex in the case of an unusual intensity of cables. If the manipulation is improper, it will affect the communication quality of other cable interfaces, and may even lead to a wrong plug and pull, so as to result in communication failure.

In the existing technology, in order to solve the drawbacks caused by plugging and pulling a single cable on a network switch, people have carried out a variety of attempts. Some people proposed the technical solution of grouping cables, and plugging and pulling each group as a whole. In other words, a group of neighboring cables having certain functions can be assembled into an overall structure, and then be plugged and pulled integrally. There are mainly two types of solutions as follows:

(1) The first solution is that a set of (normally twelve) cables (usually connected with RJ45 standard interfaces) are assembled and fixed together with a simple frame and screws, then are plugged as a whole. A drawing tool specially equipped is needed for the pull operation. This structure only has the function of plugging and pulling cables as a whole, and lacks the function of plugging and pulling one separate cable. The drawing tool can not unlock specific sites. It can only press all cable snap-fit components down as a whole, and all cables can not be pulled out completely until all of them are unlocked and released. Therefore, not only the operation is inconvenient, but also the assembled structure is oversized, and the cost is relatively high.

(2) The second solution is that a set of cables are assembled and fixed together through a specific structure, which also has the function of plugging cables as a whole. No separate tool is needed to pull cables as a whole. The unlocking and pulling out the cables as a whole is achieved by using the clamping structure arranged at its end directly. Of course, this operation requires specific inner parts to cooperate. Thus, the resulting overall structure of the device is more complex, the cost is relatively high, and inevitably the volume of the device is relatively large. The device also has the function of plugging and pulling one separate cable, but in the operation of plugging and pulling cables individually, it is necessary to use a specific operational tool. For in the maintenance process of the switch, the operation of replacing some cables individually will be conducted frequently, while the operation of plugging and pulling the cables integrally will be seldom conducted. Unless in the processes of new installation, commissioning and replacement will it be possible to conduct such an operation, so the structure and function will cause inconvenience to users instead.

### SUMMARY OF THE INVENTION

The object of the present invention is to overcome the problems and drawbacks of the prior art mentioned above. The present invention provides an improved switch pack assembly for cable clusters of network switches and the special release tool assembly thereof, which can achieve the operations of plugging and pulling a single cable arbitrarily and cables integrally. The present invention has simple and practical structures, is assembled conveniently and quickly, has stable and firm whole structures and a comprehensive application field.

In order to realize the above object, the switch pack assembly for cable clusters of network switches and the special release tool assembly thereof of the present invention has the structures as summarized in the Abstract and as detailed in the attached claims.

### DESCRIPTION OF THE FIGURES

FIG. 1 is a schematic view of the whole structure of the central framework of the switch pack assembly for cable clusters of network switches according to the present invention.

FIG. 2 is a front view of the central framework of the switch pack assembly for cable clusters of network switches according to the present invention.

FIG. 3 is a schematic view of the whole structure of the cover of the switch pack assembly for cable clusters of network switches according to the present invention.

FIG. 4 is a schematic view of the inside of the cover of the switch pack assembly for cable clusters of network switches according to the present invention.

FIG. 5 is a side schematic view of the cover of the switch pack assembly for cable clusters of network switches according to the present invention.

FIG. 6 is a schematic view of the whole assembling process of the switch pack assembly for cable clusters of network switches according to the present invention.

FIG. 7 is a schematic view of the whole structure of the clamping handle of the special release tool assembly for pulling the switch pack assembly for cable clusters integrally away from network switches according to the present invention.

FIG. 8 is a schematic view of the whole structure of the clamping handle of the special release tool assembly for pulling the switch pack assembly for cable clusters integrally away from network switches seen from another direction according to the present invention.

FIG. 9 is a side schematic view of the clamping handle of the special release tool assembly for pulling the switch pack assembly for cable clusters integrally away from network switches according to the present invention.

FIG. 10 is a schematic view of the whole assembling process of the special release tool assembly for pulling the switch pack assembly for cable clusters integrally away from network switches according to the present invention.

FIG. 11 is a schematic view of the whole structure when the special release tool assembly clamps the switch pack assembly for cable clusters according to the present invention.

### PREFERRED EMBODIMENTS OF THE INVENTION

In order to understand the technical content of the present invention clearly, the present invention is further exemplified by reference to the following examples.

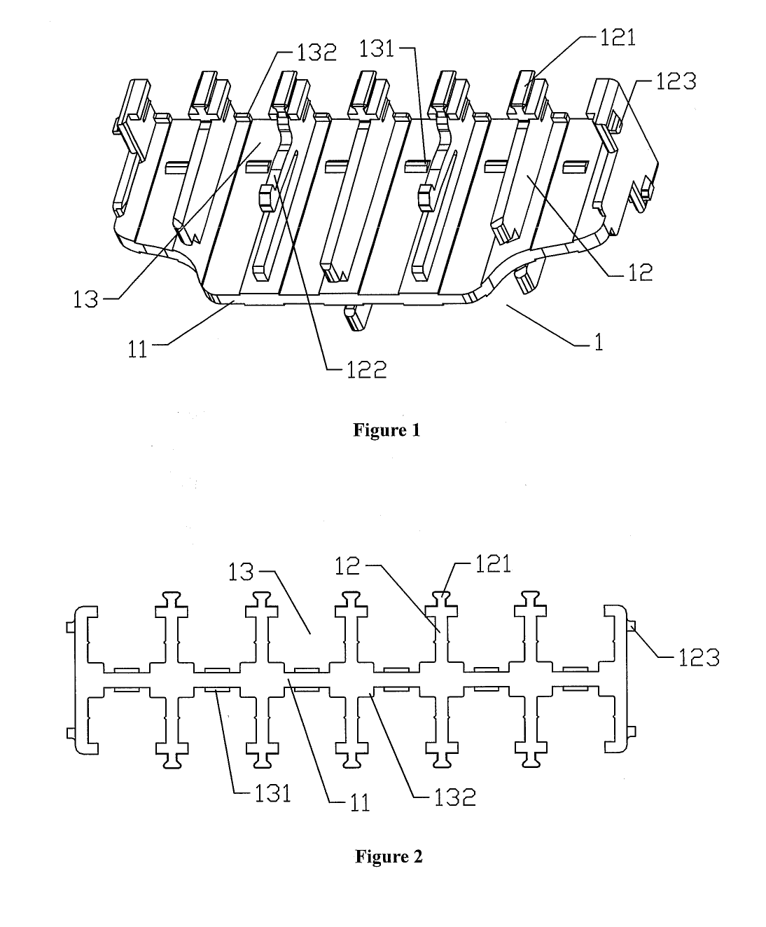

Referring to FIG. 1, FIG. 2 and FIG. 6, the switch pack assembly for cable clusters of network switches comprises a central framework 1 and two covers 2 arranged movably at two sides of the central framework 1, wherein several longitudinal parallel holding troughs 13 are arranged on the central framework 1.

The central framework 1 includes a central lateral substrate 11. On two side surfaces of the central lateral substrate 11 are arranged spaced from each other, several longitudinal clapboards 12. The longitudinal clapboards 12 are perpendicular to the central lateral substrate 11 and extend along the longitudinal direction. Each of the holding troughs 13 is formed between adjacent longitudinal clapboards 12. In accordance with one embodiment of the present invention, the longitudinal clapboards 12 are arranged on the two side surfaces of the central lateral substrate 11, and are mirror-image symmetrical with the central lateral substrate 11 as the symmetry axis. Hence, the holding troughs 13 form two layers; namely an upper layer and a lower layer. The number of the holding troughs 13 in each layer is at least two, and can be three, four, five, six or even more.

The width and the depth of the holding trough 13 should match the cable plug to be assembled in the holding trough 13. For the RJ45 patch cord, because its size is an international standard, it is very easy to determine the size of the holding trough 13.

The bottom of the RJ45 plug has a convex step. This convex step can be used to position and fixedly lock the RJ45 plug longitudinally with the holding trough 13. At a corresponding position on the bottom of the holding trough 13 (i.e. on the central lateral substrate 11), is arranged a position-limiting convex block 131, or a position-limiting looking hook. At the front end of the holding trough 13, near to the central lateral substrate 11, is arranged a position-limiting baffle 132. When the cable with the RJ45 plug is inserted into the holding trough 13, the convex step at the bottom of the plug and the position-limiting baffle 132 at the bottom of the front end of the holding trough 13 can abut against each other. The rear end of the plug abuts against the position-limiting convex block 131. The abutments achieve a very good longitudinal positioning effect and prevent the plug from slipping backward and prevent the plug from protruding forward.

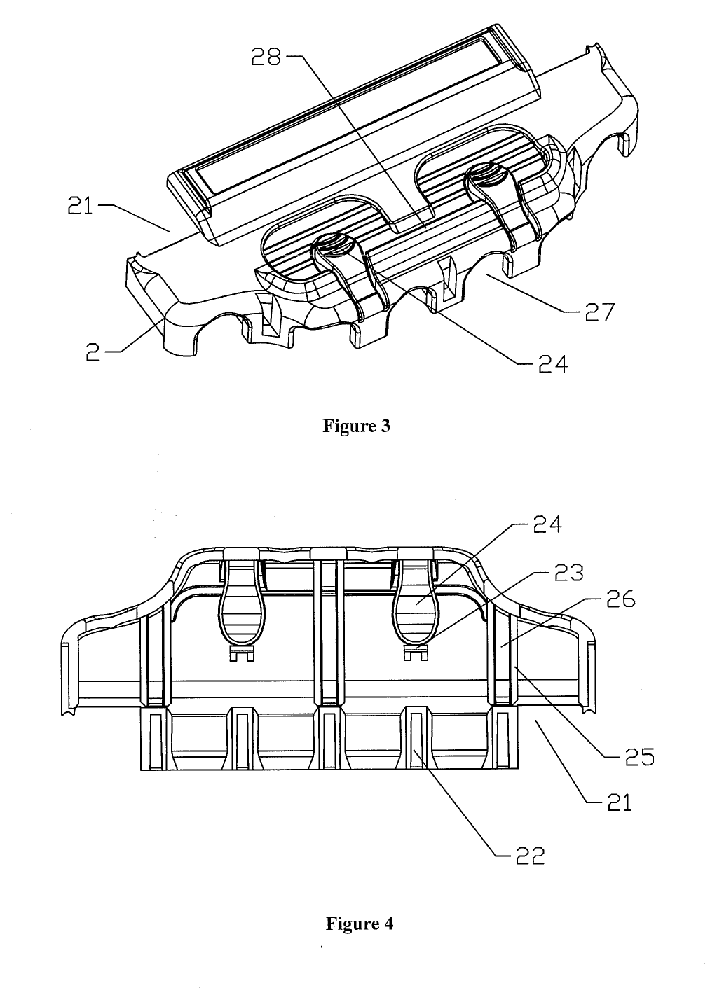

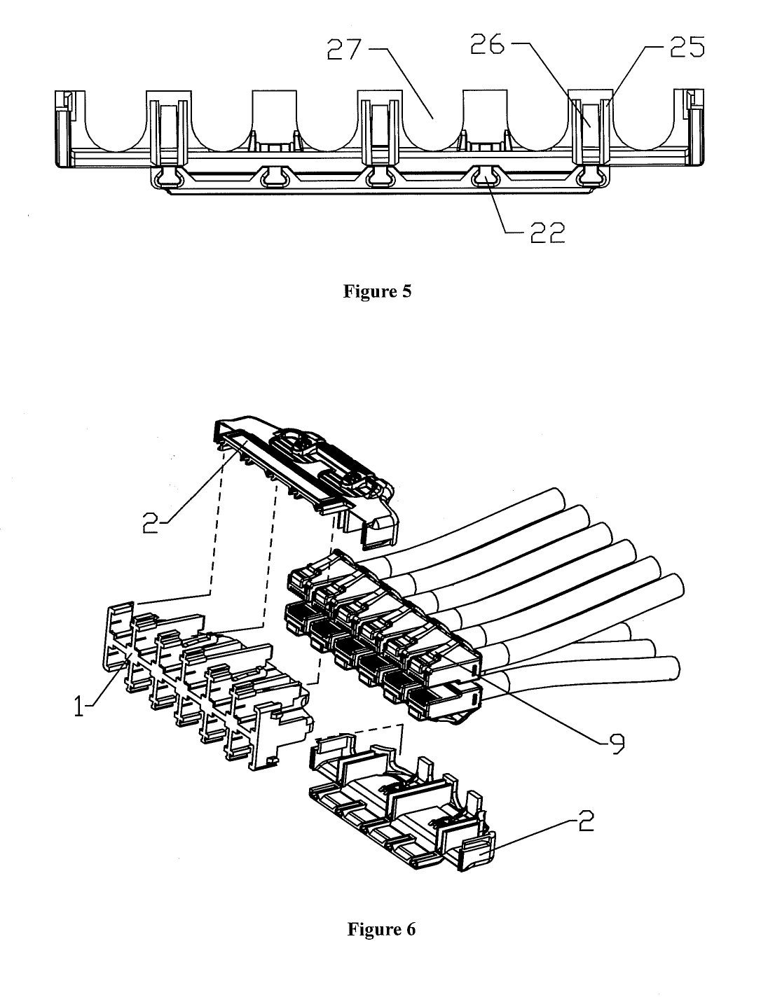

Referring to FIG. 3 through FIG. 6, each of the covers 2 locks to one of the side surfaces (e.g., upper side, lower side) of the central framework 1, as the covers slide forward in the longitudinal direction. The main body of the cover 2 covers the open ends of the holding troughs 13 to form cavities, four sides of each of which are closed.

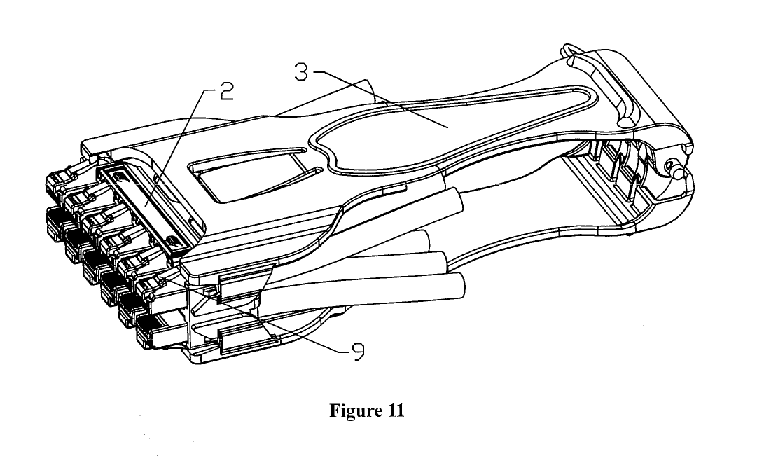

Open windows 21 are arranged at the positions on the main body of the cover 2, corresponding to the front parts of at least one pair of cavities. The open windows 21 may be distributed in bilateral symmetry along the longitudinal central axis of the cover 2. The open windows are used mainly to allow the plug snap-fit components 9 (See FIG. 11) of the plugs corresponding to the open windows 21, to pass therethrough and interface with a mating jack to lock the plugs into the jacks.

The other plug snap-fit components 9, at the plugs above which there are no open windows 21, are compressed by a portion of the cover 2. Therefore, the switch pack assembly for cable clusters can be fixed firmly to jacks of a switch by the plug snap-fit components 9 at the open windows. An unlocking operation is performed when it is desired to remove the switch pack assembly for cable clusters from the switch. The unlocking operation can be achieved by pressing only the locked cable snap-fit components 9 at the open window positions.

In order to obtain the fixation effect as good as possible, in an embodiment of the present invention, the open windows 21 on the main body of the cover 2 are arranged at the positions corresponding to the front parts of the cavities at two ends of the central framework 1. When the cover is assembled, only the plug snap-fit components 9 of four plugs near to the two ends of the central framework 1 can be locked fixedly with the jacks of the network switch. The cable snap-fit components 9 of the plugs at other positions are compressed. The above structure facilitates the plugging in, e.g., locking, and pulling out, e.g., unlocking, operations of the switch pack assembly. When the cover 2 is removed, the plug snap-fit components 9 in the middle positions, compressed previously by the cover 2, will rise up, and be locked fixedly and automatically with the jacks of the network switch. Therefore, the backward movement of the cover 2 would not move the plugs together to cause them to release from the network switch.

Between the cover 2 and at least one longitudinal clapboard 12 on the corresponding side of the central lateral substrate 11 is arranged a longitudinal sliding guide mechanism along which the cover 2 slides to and fro. In one embodiment of the present invention, the longitudinal sliding guide mechanism includes a longitudinal sliding guide rail 121. The longitudinal sliding guide rail 121 is arranged on the top part of the longitudinal clapboard 12. A longitudinal sliding guide groove 22 is also arranged on the corresponding side of the cover 2. The longitudinal sliding guide rail 121 slides to and fro in the longitudinal sliding guide groove 22, so as to achieve the reciprocating movement of the cover 2 relative to the central framework 1. The reciprocating movement ensures that users can conveniently assemble the cover 2 to the central lateral substrate 11, and can conveniently disassemble the cover 2 from the central lateral substrate 11.

Alternatively, a longitudinal sliding guide groove can be arranged on the top part of the longitudinal clapboard 12 and, a longitudinal sliding guide rail can be arranged on the corresponding side of the cover 2. The cross-sectional shape of the longitudinal sliding guide rail 121 can be any one of various shapes, as long as it can be positioned fixedly along the direction perpendicular to the sliding direction of the rail. In illustrated embodiment of the present invention, the shape adopted is a “T” shape. However, other shapes can be chosen, such as “Y”, “V”, “L”, “F”, “E”, “C”, “S” or “Z” shapes, so long as the cross-sectional shape of the longitudinal sliding guide groove 22 complementarily matches the shape of the longitudinal sliding guide rail 121, and ensures that the cover 2 can be positioned firmly and fixedly along the direction perpendicular to the central framework 1 and slide freely and stably along the longitudinal direction.

Additionally, between the cover 2 and at least one longitudinal clapboard 12 on the corresponding side of the central lateral substrate 11 is arranged a longitudinal movable snap-fit mechanism. The longitudinal movable snap-fit mechanism is used to allow the cover 2 to be positioned and locked stably on the central framework 1. The longitudinal movable snap-fit mechanism would not be released when the whole switch pack assembly for cable clusters is plugged in and pulled out. In order to obtain a more stable positioning effect, the longitudinal movable snap-fit mechanisms can be arranged respectively on at least one pair of the longitudinal clapboards 12 distributed by bilateral symmetry along the longitudinal central axis of the cover 2. In one embodiment of the present invention, the number of the longitudinal movable snap-fit mechanisms is two in general, and they are arranged respectively on two longitudinal clapboards 12 nearest to the longitudinal central axis of the cover 2.

The longitudinal movable snap-fit mechanism can include an elastic locking tendon 122 arranged on one longitudinal clapboard 12 and a locking hook 23 arranged on a corresponding location of the cover 2. On the location of the cover 2 corresponding to the elastic locking tendon 122 is further arranged movably an elastic push button 24, the lower part of which props against the elastic locking tendon 122. Alternatively, a locking slot can be arranged on the longitudinal clapboard 12.

Referring to FIG. 3 to FIG. 6, on the location of the cover 2 corresponding to at least one longitudinal clapboard 12, on the corresponding side of the central lateral substrate 11 of the central framework 1, is arranged a position-limiting guide mechanism. The position-limiting guide mechanism includes a pair of position-limiting longitudinal guide plates 25 arranged on two sides of the place of the cover 2 corresponding to the longitudinal clapboard 12. the guide plates 25 are perpendicular to the main body of the cover 2 and extend along the longitudinal direction. Between the position-limiting longitudinal guide plates 25 is formed a guide slot 26 into which the longitudinal clapboard 12 is inserted.

In order to make the guide function more precise and stable, and easier to use, the position-limiting guide mechanisms can be arranged respectively on the locations of the cover 2 corresponding to at least one pair of the longitudinal clapboards 12, distributed by bilateral symmetry along the longitudinal central axis of the cover 2. In one embodiment of the present invention, the position-limiting guide mechanisms are arranged respectively on the locations of the cover 2 corresponding to the center longitudinal clapboard 12, e.g., nearest to the longitudinal central axis of the cover 2, and corresponding to the pair of the longitudinal clapboards 12 most far away from the longitudinal central axis of the cover 2.

Referring to FIG. 3 to FIG. 6, at the rear end of the cover 2 are further arranged cable-oriented notches 27 corresponding to and cooperating with the cable-oriented cavities mentioned above respectively. The bottom parts of the cable-oriented notches 27 prop directly against the rear part of the central lateral substrate 11 of the central framework 1, so as to form together cable-oriented position-limiting holes. The cable-oriented position-limiting holes are used mainly to restraint and position the rear parts of the cables, and prevent adjacent cables from twisting. This arrangement facilitates the management of cables, such that the corresponding relationship of the cables and the interfaces (e.g., plugs in jacks) of the network switch are known.

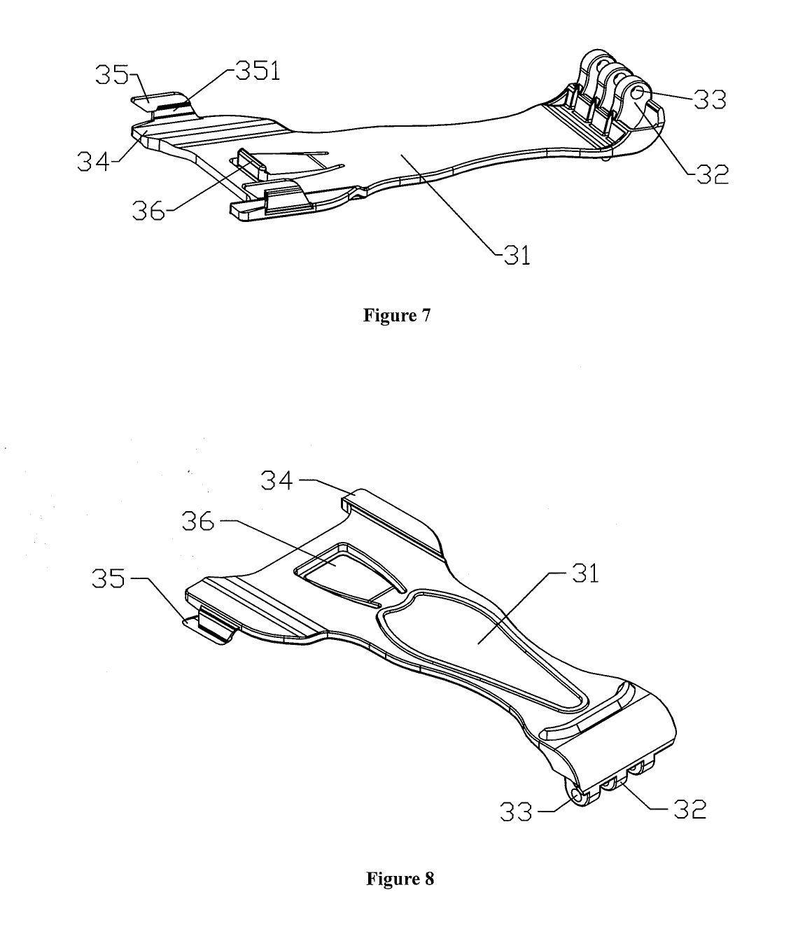

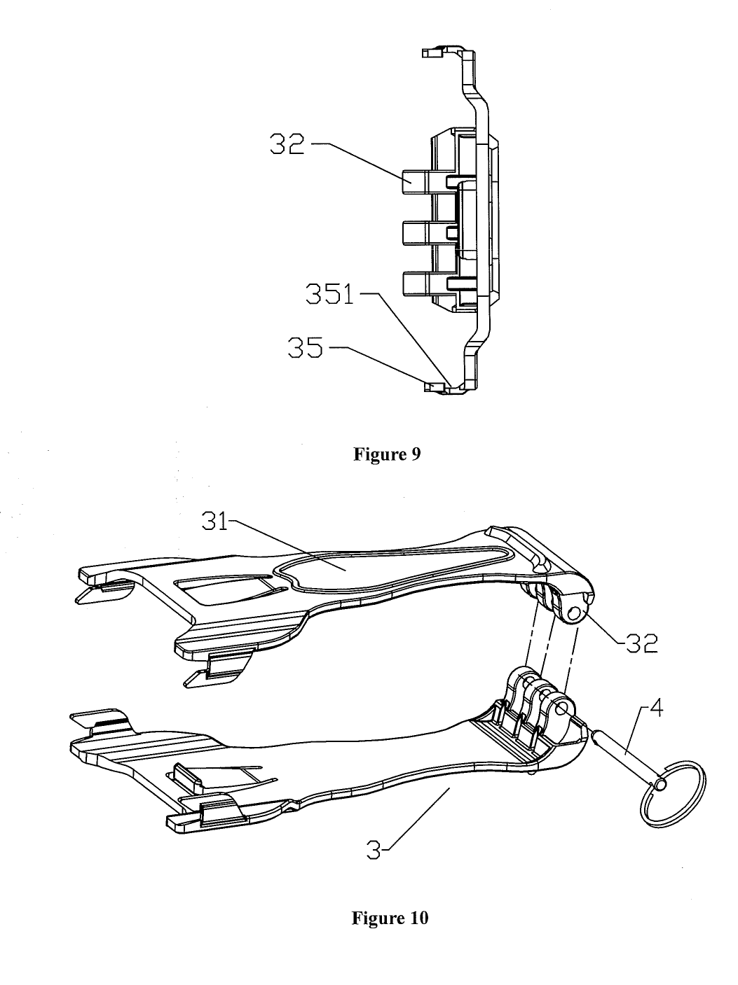

Referring to FIG. 7 to FIG. 11, in order to ensure that the switch pack assembly for cable clusters of network switches of the present invention can be plugged in and pulled out integrally and conveniently when the cables are intensive (e.g., dense in placement) and a person's hands can not touch the cable snap-fit components 9, the present invention further provides a special release tool assembly 3. The release tool assembly 3 is provided for pulling the above mentioned switch pack assembly for cable clusters integrally away from network switches. The special release tool assembly 3 comprises a pair of clamping handles 31. The rear ends of clamping handles 31 are hinged movably with each other. In one embodiment of the present invention, the rear ends of the clamping handles 31 include hinged pivots 32. The hinged pivots 32 on the clamping handles 31 are inserted spacedly and staggeredly into each other until central shaft holes 33 of the hinged pivots 32 coincide with each other. A hinge 4 is inserted into and fixed in the central shaft holes 33 of the hinged pivots 32. The hinge 4 allows the pair of the clamping handles 31 to rotate around the hinge 4, so as to open a certain angle and clamp the above mentioned switch pack assembly for cable clusters.

The shape of the front end of the clamping handle 31 matches the shape of the switch pack assembly for cable clusters. At positions of the front end of the clamping handle 31, corresponding to the open windows 21 on the cover 2, are arranged pressure plates 34. In one embodiment of the present invention, the pressure plates 34 are arranged at positions corresponding to the front parts of the cable-oriented cavities at two ends of the central framework 1. Therefore, after the user clamps the switch pack assembly for cable clusters with the clamping handles 31, the pressure plates 34 compress the plug snap-fit components 9 on the plugs in the open windows, so as to unlock the plugs from the jacks of the network switches. Once the plugs are unlocked, the whole switch pack assembly for cable clusters can be pulled out of the network switches smoothly.

In order to guide and position the special release tool assembly better during the clamping process, a longitudinal sliding guide component is further arranged on the outside of the switch pack assembly for cable clusters. In one embodiment of the present invention, the longitudinal sliding guide component includes two longitudinal sliding guide convex blocks 123 on the lateral surfaces of the longitudinal clapboards 12. The two longitudinal sliding guide convex blocks 123 are arranged at two ends of the central lateral substrate 11 of the central framework 1. At the same time, at the position of the inside of the front end of the clamping handle 31 corresponding to the longitudinal sliding guide component of the switch pack assembly for cable clusters is arranged a longitudinal sliding positioning mechanism. In one embodiment of the present invention, at two sides of the front end of the clamping handle 31 are all arranged position-limiting baffle plates 35. The position-limiting baffle plates 35 are perpendicular to the plane of the clamping handle 31 and extend into the inside of the special release tool assembly.

The longitudinal sliding positioning mechanism includes two longitudinal sliding guide grooves 351 arranged at the insides of the position-limiting baffle plates 35 and corresponding to the longitudinal sliding guide convex blocks 123 on the lateral surfaces of the longitudinal clapboards 12 at two ends of the central lateral substrate 11. By this arrangement, the longitudinal sliding guide convex blocks 123 slide to and fro in the longitudinal sliding guide grooves 351 respectively, and provide very good guiding and positioning for the sliding action between the clamping handles 31 and the central lateral substrate 11. The guidance feature prevents the special release tool assembly 3 from deviating from the right position during the clamping process and unlocking process.

Alternatively, two longitudinal sliding guide grooves can be arranged on the two ends of the central lateral substrate 11 instead of the two longitudinal sliding guide convex blocks 123. If two longitudinal sliding guide grooves are used on the central lateral substrate 11, then the longitudinal sliding positioning mechanism of the clamping handles 31 can adopt two longitudinal sliding guide convex blocks. This gender reversed arrangement can also generate the guiding and positioning effect for the sliding action between the clamping handles 31 and the central lateral substrate 11.

In order to cause the switch pack assembly for cable clusters to be pulled out smoothly after the special release tool assembly clamps and unlocks the switch pack assembly for cable clusters, the special release tool 3 includes a pulling mechanism, and a whole-body-pulling resisting component is arranged on the outside of the switch pack assembly for cable clusters. In one embodiment of the present invention, the whole-body-pulling resisting component is a lateral resisting convex bar 28 (see FIG. 3) arranged between the two elastic push buttons 24. The lateral resisting convex bar 28 is at the middle part of the outside of the cover 2. At a position in the inside of the front end of the clamping handle 31 corresponding to the lateral resisting convex bar 28 of the switch pack assembly for cable clusters is arranged a pulling force-applying mechanism. The pulling force-applying mechanism is a lateral pulling elastic locking hook 36 arranged at the inside of the front end of the clamping handle 31. When the clamping handle 31 is in position, the lateral pulling elastic locking hook 36 overlaps the lateral resisting convex bar 28 between two elastic push buttons 24 at the middle part of the outside of the cover 2. The lateral pulling elastic locking hook 36 hooks the lateral resisting convex bar 28 in the middle part of the outside of the cover 2, so that the switch pack assembly for cable clusters can be pulled integrally and smoothly out of the network switch by using the pulling force-applying mechanism to act on the whole-body-pulling resisting component.

Alternatively, the structure of a lateral resisting groove can be adopted instead of the lateral resisting convex bar 28. The lateral resisting groove can play the same resisting function. When the whole-body-pulling resisting component adopts the lateral resisting groove configuration, the lateral pulling elastic locking hook 36 can hook the lateral resisting groove at the middle part of the outside of the cover 2, so as to complete the pulling operation.

It should be understood that the content described above shows various embodiments of the present invention and the technical principles used in the present invention. After reading the above content of the present invention, technicians skilled in the art can make various modifications or changes to the present invention without departure from the spirit and scope of the present invention. These equivalent forms should also fall within the scope of the present invention.

1-22. (canceled)

23. A switch pack assembly for cable clusters comprising:
a central framework including a first plurality of plug holding troughs; and
a first cover movably mounted to a first side of said central framework, said first cover being able to slide relative to said central framework into a locked position relative to said central framework, wherein said first cover forms a first plurality of plug holding cavities when in said locked position;
wherein said first cover includes at least one open window positioned above at least one of said first plurality of plug holding troughs, wherein said at least one window is sized to allow access to a latch of a plug when a plug is located within said at least one of said first plurality of plug holding troughs.

24. The switch pack assembly for cable clusters according to claim 23, wherein said central framework includes:
a substrate;
a first plurality of clapboards extending substantially perpendicular to said substrate and residing on said first side of said central framework, wherein each plug holding trough of said first plurality of plug holding troughs is formed between adjacent clapboards of said first plurality of clapboards.

25. The switch pack assembly for cable clusters according to claim 24, wherein at least one clapboard of said first plurality of clapboards includes a first sliding guide mechanism, and wherein said first cover includes a second, complimentary sliding guide mechanism engaged to said first sliding guide mechanism to permit said first cover to slide relative to said central framework.

26. The switch pack assembly for cable clusters according to claim 25, wherein said first sliding guide mechanism includes a sliding guide rail on an end part of said at least one clapboard, and wherein said second sliding guide mechanism includes a sliding guide groove arranged on said first cover.

27. The switch pack assembly for cable clusters according to claim 24, wherein at least one clapboard of said first plurality of clapboards includes a snap-fit mechanism and wherein said first cover includes a second, complimentary feature to engage said snap-fit mechanism when said first cover is in said locked position.

28. The switch pack assembly for cable clusters according to claim 27, wherein said snap-fit mechanism includes an elastic locking tendon arranged on an end part of said least one clapboard of said first plurality of clapboards, and wherein said complimentary feature includes a locking hook formed on said first cover.

29. The switch pack assembly for cable clusters according to claim 28, wherein said first cover includes an elastic push button positioned over said elastic locking tendon when said first cover is in said locked position relative to said central framework, and wherein said elastic push button may be manually pressed to release said elastic locking tendon from said locking hook formed on said first cover, such that said first cover may be slid away of the locked position with said central framework.

30. The switch pack assembly for cable clusters according to claim 23, wherein said at least one window includes a first open window arranged over a first plug holding trough at a first end of said central framework and a second open window arranged over a second plug holding trough at a second end of said central framework, opposite to said first end of said central framework.

31. The switch pack assembly for cable clusters according to claim 23, further comprising:
a second cover movably mounted to a second side of said central framework, said second cover being able to slide relative to said central framework into a locked position relative to said central framework, wherein said second cover forms a second plurality of plug holding cavities when in said locked position;
wherein said second cover includes at least one open window positioned above at least one of said second plurality of plug holding troughs, wherein said at least one window is sized to allow access to a latch of a plug when a plug is located within said at least one of said second plurality of plug holding troughs.

32. The switch pack assembly for cable clusters according to claim 31, wherein said central framework includes:
a substrate;
a first plurality of clapboards extending substantially perpendicular to said substrate and residing on said first side of said central framework, wherein each plug holding trough of said first plurality of plug holding troughs is formed between adjacent clapboards of said first plurality of clapboards.
a second plurality of clapboards extending substantially perpendicular to said substrate and residing on said second side of said central framework, wherein each plug holding trough of said second plurality of plug holding troughs is formed between adjacent clapboards of said second plurality of clapboards.

33. The switch pack assembly for cable clusters according to claim 23, further comprising:
a plurality of communication plugs with locking latches, each plug being located in one of first plurality of plug holding cavities, wherein a plug located in a plug holding cavity beneath an open window of said first cover has its locking latch free to snap lock into a jack, and wherein a plug located in a plug holding cavity which is not beneath an open window of said first cover has its locking latch depressed by a portion of said first cover so that the depressed locking latch cannot snap lock into a jack.

34. The switch pack assembly for cable clusters according to claim 23, wherein each plug holding cavity of said first plurality of plug holding cavities includes fours sides, each of which is closed.

35. The switch pack assembly for cable clusters according to claim 23, further comprising:
a hole-body-pulling resisting component arranged on an outside of said first cover.

36. The switch pack assembly for cable clusters according to claim 23, further comprising:
a release tool for releasing a mated switch pack assembly for cable clusters, said release tool including:
a handle, wherein a front end of said handle is shaped to fit over said first cover of said switch pack assembly for cable clusters; and
pressure plates located at said front end of said handle, wherein said pressure plates are located at opposite lateral ends of said front end of said handle and are adapted to depress latches of plugs within said switch pack assembly for cable clusters when said release tool is mated to said switch pack assembly for cable clusters.

37. The switch pack assembly for cable clusters according to claim 36, wherein said release tool further includes a pulling locking hook proximate said front end of said handle, wherein said first cover includes a hole-body-pulling resisting component arranged on an outside of said first cover, and wherein said pulling locking hook engages said hole-body-pulling resisting component when said front end of said handle is fitted over said first cover.

38. The switch pack assembly for cable clusters according to claim 31, further comprising:
a release tool for releasing a mated switch pack assembly for cable clusters, said release tool including:
a first handle, wherein a front end of said first handle is shaped to fit over said first cover of said switch pack assembly for cable clusters;
first pressure plates located at said front end of said first handle, wherein said first pressure plates are located at opposite lateral ends of said front end of said first handle and are adapted to depress latches of plugs within said switch pack assembly for cable clusters when said release tool is mated to said switch pack assembly for cable clusters;
a second handle, wherein a front end of said second handle is shaped to fit over said second cover of the switch pack assembly for cable clusters; and
second pressure plates located at said front end of said second handle, wherein said second pressure plates are located at opposite lateral end of said front end of said second handle and are adapted to depress latches of plugs within the switch pack assembly for cable clusters when said release tool is mated to the switch pack assembly for cable clusters.

39. The switch pack assembly for cable clusters according to claim 38, wherein a rear end of said first handle includes first shaft holes, and wherein a rear end of said second handle includes second shaft holes, and further comprising:
a hinge inserted into said first and second shaft holes to permit said first handle and second handle to rotate around said hinge.

40. A release tool for releasing a mated switch pack assembly for cable clusters, said release tool comprising:
a handle, wherein a front end of said handle is shaped to fit over a first cover of a switch pack assembly for cable clusters; and
pressure plates located at said front end of said handle, wherein said pressure plates are located at opposite lateral ends of said front end of said handle and are adapted to depress latches of plugs within the switch pack assembly for cable clusters when said release tool is mated to the switch pack assembly for cable clusters.

41. The release tool according to claim 40, wherein said handle is a first handle and wherein said pressure plates are first pressure plates, and further comprising:
a second handle, wherein a front end of said second handle is shaped to fit over a second cover of the switch pack assembly for cable clusters; and
second pressure plates located at said front end of said second handle, wherein said second pressure plates are located at opposite lateral end of said front end of said second handle and are adapted to depress latches of plugs within the switch pack assembly for cable clusters when said release tool is mated to the switch pack assembly for cable clusters.

42. The release tool according to claim 41, wherein a rear end of said first handle includes first shaft holes, and wherein a rear end of said second handle includes second shaft holes, and further comprising:
a hinge inserted into said first and second shaft holes to permit said first handle and second handle to rotate around said hinge.
